(19) United States
(12) Patent Application Publication
(10) Pub. No.: US 2023/0109514 A1
(43) Pub. Date: Apr. 6, 2023

(54) A CRIMP SLEEVE FOR JOINING WIRE ENDS AND METHOD FOR PRODUCING SUCH A SLEEVE

(71) Applicant: HUSQVARNA AB, Huskvarna (SE)

(72) Inventors: Sébastien Michotte, Louvain-la-Neuve (BE); Philippe Uytters, Wezembeek-Oppem (BE)

(21) Appl. No.: 17/786,992

(22) PCT Filed: Dec. 9, 2020
(86) PCT No.: PCT/SE2020/051188

§ 371 Date: Jun. 17, 2022

Related U.S. Application Data
Application No. PCT/SE2020/051188 is a continuation-in-part of application No. PCT/SE2019/051316, filed on Dec. 19, 2019.

(30) Foreign Application Priority Data
Dec. 19, 2019 (WO) PCT/SE2019/051316

(51) Int. Cl. B21F 15/06; B28D 1/12

(52) U.S. Cl. CPC B21F 15/06; B28D 1/124

(57) ABSTRACT

A crimp sleeve (200) for joining two wire ends, wherein the crimp sleeve is arranged to receive (245) the wire ends from opposite sides along an axial direction (240) of the sleeve, the crimp sleeve having an outer circumferential surface (210) and an inner circumferential surface (220), wherein the outer circumferential surface (210) comprises a guiding structure (230) arranged to guide a crimping tool to crimp the sleeve at one or more pre- determined axial rotation angles (260).

### TECHNICAL FIELD

The present disclosure relates to wire saws for processing hard materials such as stone and concrete. There are disclosed crimp sleeves for joining two wire ends, methods for joining wire ends, and methods for manufacturing crimp sleeves for wire saws.

### BACKGROUND

A wire saw uses an elongated carrier, such as a wire or cable, for cutting or selectively abrading hard materials. Wire saws may be continuous where the elongated carrier is arranged in a loop, or they may be non-continuous, where the carrier has open ends.

Wire saws generally provide a cutting action via an abrasion effect rather than via saw teeth. The abrasion effect may be enhanced by bonding abrasive particles to the carrier, such as abrasive beads.

A continuous wire without ends can be formed by connecting two ends of a wire together. A longer segment of wire can also be formed by connecting the ends of two or more shorter wires together. To connect wire ends, crimp sleeves can be used.

A crimp sleeve is a tubular deformable structure which can be permanently deformed. The wire ends are inserted into the crimp sleeve, and the sleeve is compressed, i.e., deformed, to hold the wire ends. The deformity is called the crimp.

The connection point between two wire ends is normally a weak point in the wire saw. The wire ends may come loose from the crimp sleeve, and the wire itself may break due to fatigue in connection to the crimp sleeve wire end connection. There is a need for improved crimp sleeves for wire saws.

### SUMMARY

It is an object of the present disclosure to provide improved crimp sleeves. This object is obtained by a crimp sleeve for joining two wire ends. The crimp sleeve is arranged to receive the wire ends from opposite sides along an axial direction of the sleeve. The crimp sleeve has an outer circumferential surface and an inner circumferential surface. The outer circumferential surface comprises a guiding structure arranged to guide a crimping tool to crimp the sleeve at one or more pre-determined axial rotation angles.

This means that an operator has a means to align the crimp sleeve with respect to the crimp tool, and thereby crimp the sleeve at a pre-determined rotation angle. This angle will be the same for every crimp, which is an advantage.

According to aspects, the inner circumferential surface defines an inner volume arranged to receive the wire ends in fixed relation to the one or more axial rotation angles. This way the crimp force is pre-determined in relation to the axial rotation of the crimp sleeve in the tool as well as the rotation of the wire inside the sleeve. This enables the production of crimp sleeves having different properties in terms of tensile strength and bend fatigue resistance, which will be explained in more detail below.

According to aspects, the guiding structure comprises two or more ridges extending axially along the outer circumferential surface. The ridges provide a less pronounced transition between facet surfaces of the crimp sleeve after crimping. The lack of sharp edges after crimping reduce marks on the abraded material and also make the crimp sleeve connection more robust to mechanical shock.

According to aspects, the crimp sleeve comprises six ridges evenly distributed around the outer circumferential surface. Each pair of ridges is arranged to support the crimp sleeve in the crimping tool at one of the one or more pre-determined axial rotation angles. The ridges represent an efficient means or at least an alternative for supporting the sleeve in the crimping tool.

According to aspects, the guiding structure comprises one or more facet surfaces. Each facet surface is arranged to support the crimp sleeve in the crimping tool at a respective pre-determined axial rotation angle. The facets represent an efficient means or at least an alternative for supporting the sleeve in the crimping tool.

According to aspects, the guiding structure is divided axially into a first portion and a second portion. The first portion of the guiding structure is axially rotated with respect to the second portion of the guiding structure.

The axial rotation means that the overall exterior shape of the crimp sleeve after crimping is more cylindrical, since the facets are rotated with respect to each other. The reduction in protruding portions means that a smoother cutting action is obtained, and also an increased resistance to mechanical shock.

According to aspects, the inner circumferential surface comprises a respective protrusion for each wire end configured to enter a space between two strands of the wire end, whereby the wire ends are received in the inner volume in fixed relation to the one or more axial rotation angles. Thus, the wire ends are received in fixed relation to the one or more axial rotation angles discussed above.

According to aspects, the inner circumferential surface comprises a helical ridge configured to enter a space between two strands of a wire end, whereby the wire ends are received in fixed relation to the one or more axial rotation angles. The helical ridge is like a footprint of the wire strands. This means that the friction between the wire ends and the inner circumferential surface is increased, since the wire ends now have to overcome the resistance from the helical ridges in order to be pulled out from the crimp sleeve. The result is a crimp sleeve connection of increased tensile strength. Another advantage, due to the increase in friction, is that a shorter sleeve can be used. This in turn increases the resistance of the crimp sleeve connection to material fatigue due to bending during use of the wire, which is an advantage.

According to aspects, the inner circumferential surface is configured with a shape that is matched to an exterior profile of the wire ends. This matching provides a further increase in friction.

According to aspects, an opening of the sleeve configured to receive a wire end has a funnel shape with a chamfer radius between 0.5-2.0 mm. The funnel shape reduces bending stresses on the wire during use, which leads to a reduction in fatigue, which is an advantage.

According to aspects, the inner volume is configured with play relative to a diameter of the wire ends. This simplifies insertion of the wire ends into the crimp sleeve, thereby simplifying assembly.

According to aspects, the sleeve is divided into first and second articulated parts, where each part is arranged to receive a respective wire end. The articulated joint provides a further reduction in fatigue due to bending, since the bend forces become less pronounced.

According to aspects, a forward end of the crimp sleeve, i.e., the end of the crimp sleeve facing in the forward direction F as indicated in FIG. 18, comprises one or more chamfered sections. As the sleeve enters a groove, the chamfered sections guide the crimp sleeve into the groove, thus reducing strain on the sleeve. Due to the chamfered sections the sleeve is also less exposed to shocks and strain since there is a smaller risk that the edges of the crimp sleeve snag on the walls of the groove. According to further aspects, at least one chamfered section is spoon-shaped. This further reduces friction and shocks experienced by the crimp sleeve.

There is also disclosed herein a crimp sleeve arranged to join two ends of a wire for a wire saw. The crimp sleeve is arranged to receive the wire ends from opposite sides along an axial direction of the sleeve. The crimp sleeve has an outer circumferential surface and an inner circumferential surface. Each wire end has a surface shape and wherein the inner circumferential surface has a shape which is at least partially complementary wire end surface shape.

By means of the complementary shape, friction between the inner surface of the crimp sleeve and the outer surface of the wire ends is increased, which is an advantage as discussed above.

The object of the present disclosure is also obtained by methods, wires, and wire saws which are disclosed herein.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows a crimp sleeve according to prior art;

FIGS. 2-4 illustrate an example crimp sleeve;

FIGS. 5-7 illustrate another example crimp sleeve;

FIGS. 8A-B show crimp sleeve cross sections;

FIGS. 9-11 illustrate yet another example crimp sleeve;

FIGS. 12-13 schematically illustrate a crimping tool;

FIGS. 14A-B schematically illustrate a crimping method;

FIG. 15 is a graph showing charge vs. wire displacement;

FIG. 16 is a flow chart illustrating methods; and

FIGS. 17-19 illustrate an example crimp sleeve.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

A wire rope is a structure composed of a plurality of individual wires. There are two major structural elements in a typical wire rope. One is the strand which is formed by helically winding wires around a central wire or a strand core. Different shapes of strand may be formed depending on the shape of the core. The core is normally made of natural fibers, polypropylene, or steel that will provide support for the strands under bending and loading during use of the wire. Different wire structures are used, but the wires for wire saws normally consist of 7 strands, although the details of the constitution of those strands can differ.

The lay length or pitch of a wire is the distance measured parallel to the wire helix axis around which the centroidal axis of a wire makes one complete helical convolution.

Wires for wire saws are normally configured with diameters on the order of 2 mm to about 8 mm. The pitch of a wire for a wire saw is normally configured as 24 mm for a cable of diameter 3.80 mm, 32 mm for cable of diameter 4.45 mm and 35 mm for cable of diameter 4.85 mm. Other pitch configurations are of course also possible.

Metal fatigue is a weakening of metal due to stress, resulting in an accumulation of small cracks which eventually lead to failure. Wires may experience fatigue if they are subjected to repeated bends, which is the case when a wire passes over a pulley or the like.

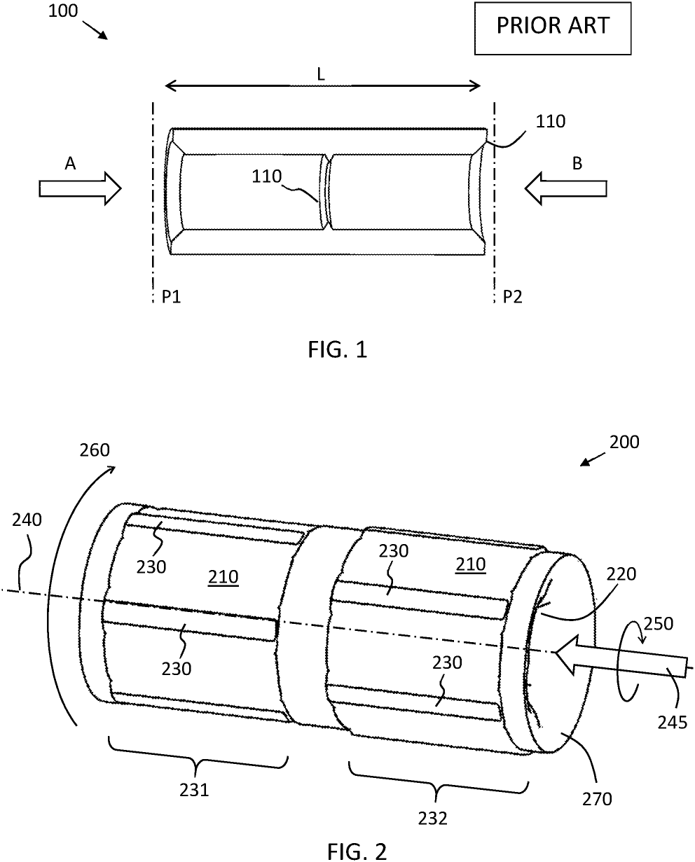

FIG. 1 illustrates a crimp sleeve 100 according to prior art. A first wire end is inserted into the crimp sleeve, see arrow A, until it abuts a stopping member 110. A crimping tool is then used to deform the sleeve 100 to hold the wire end in position. The process is then repeated by inserting a second wire end into the sleeve from the opposite end, see arrow B.

A problem with known crimp sleeves such as that in FIG. 1 is that the wire ends may be pulled out from the sleeve interior. This is due to lack of friction between the surface of the wire end and the inner circumferential surface of the crimp sleeve. To increase friction a higher crimping force can be used, but then there is a risk that the wire ends become damaged, leading to premature fatigue failure.

Another problem with the known crimp sleeves is that the wire suffers from fatigue due to repeated bending. This fatigue often causes wire rupture close to the sleeve, somewhere around the planes P1 and P2. The longer the sleeve is, i.e., the larger its extension L is in the sleeve axial direction, the more pronounced is the bend and so also the fatigue effects.

The fatigue due to bending is increased by the sharp edges 110 around the opening of the sleeve. Also, the length L of the sleeve affects the amount of fatigue due to bending. Longer sleeves often exhibit more pronounced fatigue due to bending.

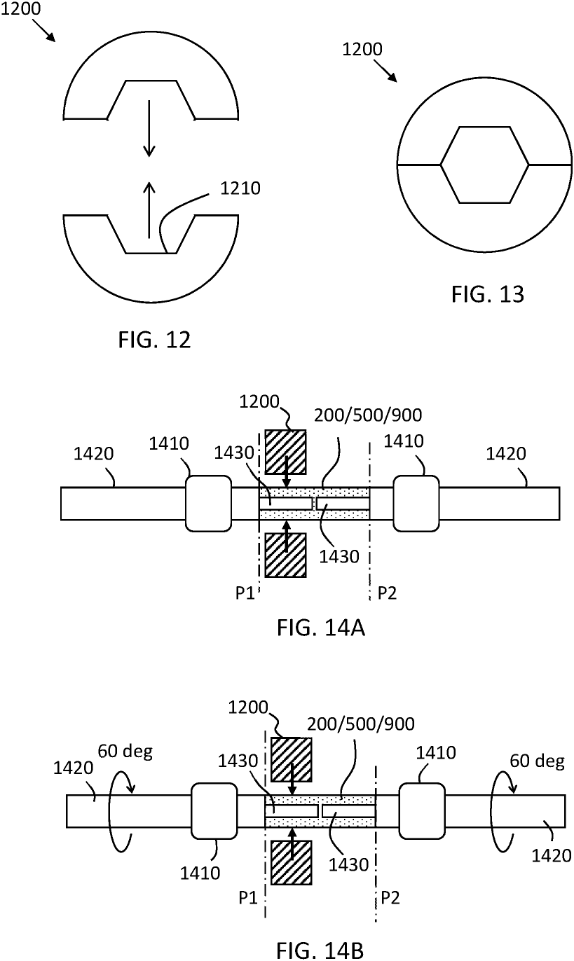

FIGS. 12 and 13 schematically illustrate a crimping tool 1200. The crimping tool is normally separable into halves such that a crimp sleeve can be received by the tool. The two halves are then pressed together, as shown in FIG. 13, such that the sleeve is permanently deformed, i.e., ‘crimped’, thereby locking the two wire ends in position. Crimping tools are known in general and will therefore not be discussed in more detail herein.

It has been realized that the orientation of the sleeve with respect to the crimping tool 1200 plays an important role when it comes to the resulting tensile strength and fatigue resistance of the wire connection. Depending on the axial rotation angle at which the sleeve is introduced into the tool, different properties can be obtained. However, known crimp sleeves do not comprise any guiding structure on the outer surface which allows an operator to efficiently orient the crimp sleeve axial rotation with respect to the crimping tool. It is difficult to crimp the sleeve in the same way every time, due to the lack of guides on the crimp sleeve, i.e., it is hard to achieve repeatability of the wire end connecting operation. This in turn means that is becomes more difficult to analyze properties such as mean time between wire connection failures and the like.

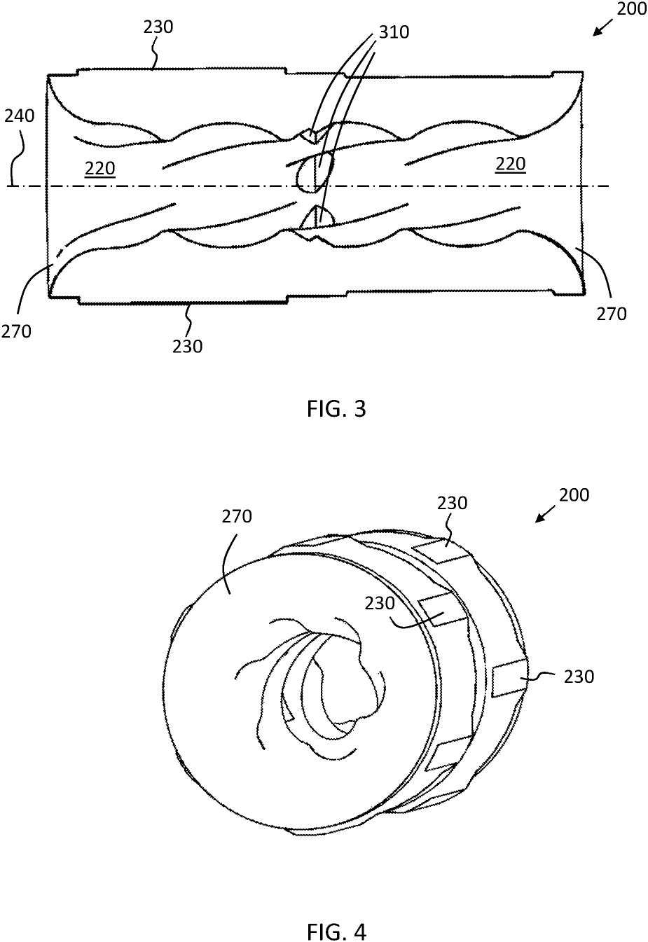

FIGS. 2-4 show a crimp sleeve 200 for joining two wire ends. The crimp sleeve is arranged to receive the wire ends from opposite sides along an axial direction 240 of the sleeve (one end is received along arrow 245, the other end from the opposite direction). The crimp sleeve has an outer circumferential surface 210 and an inner circumferential surface 220 (better seen in FIG. 3). A crimp sleeve is normally tubular, such as cylindrically shaped. However, the outer circumferential surface 210 here comprises a guiding structure 230 arranged to guide a crimping tool 1200 to crimp the sleeve at one or more pre-determined axial rotation angles 260. The guiding structure acts as a support, such that an operator can insert the crimp sleeve into the crimping tool at a pre-determined axial rotation angle.

The diameter of the tubular structure, not considering the guiding structure, is preferably about 7.5 mm for a 3.80 mm wire, 8.1-8.2 mm for the 4.45 mm wire and 9 mm for the 4.85 mm wire. Diameters of the tubular structure for smaller sized wires, such as wire dimensions between 2 mm to about 3.5 mm is smaller compared to the above mentioned diameter values.

The length of the crimp sleeve is preferably on the order of 16-20 mm. It is appreciated that shorter crimp sleeves often result in less wire fatigue due to bending of the wire as it passes over, e.g., a pulley. However, shorter sleeves are at the same time associated with a reduced tensile strength. Thus, there is normally a tradeoff to be made between tensile strength and resistance to metal fatigue due to wire bending.

The example crimp sleeve shown in FIGS. 2-4 has a guiding structure 230 which comprises two or more ridges extending axially 240 along the outer circumferential surface 210. These ridges present the additional advantage that the edges of the hexagon cross section shape after crimping are less sharp or pronounced, i.e., smoother in a sense, thus reducing stone marking by the crimp sleeve and also increasing resistance to mechanical shock. In other words, the ridges provide a less pronounced transition between the hexagonal facets of the crimp sleeve after crimping. It is appreciated that the ridges represent a feature that can be used independently of the other features disclosed herein, to obtain the feature of the less pronounced transition between sleeve facets after crimping.

Thus, there is disclosed herein a crimp sleeve 200 for joining two wire ends. The crimp sleeve is arranged to receive 245 the wire ends from opposite sides along an axial direction 240 of the sleeve. The crimp sleeve has an outer circumferential surface 210 and an inner circumferential surface 220, wherein the outer circumferential surface 210 comprises six ridges evenly distributed circumferentially and extending axially 240 along the outer circumferential surface 210.

Pairs of ridges may also be arranged to support the crimp sleeve in the crimping tool 1200 at one of the one or more pre-determined axial rotation angles 260. For example, with reference to FIG. 12, it is appreciated that two axially extending ridges can be configured to form a support against one of the facets of the crimping tool, since the plane between the ridges matches a facet of the crimping tool. The ridges will prevent rotating the crimp sleeve in the crimping tool to axial rotation angles other than a pre-determined set of allowable rotation angles. For the example crimp sleeve 200 and the example crimping tool 1200, those allowable rotation angles are multiples of 60 degrees (simply since there are six evenly distributed facets along the circumference of the crimping tool).

As mentioned above, the ridges also serve the purpose of providing a less pronounced transition between the hexagonal facets after crimping. Thus, the ridges can be used independently of the other features disclosed herein to provide a smoother crimp sleeve form after crimping, without sharp edges marking the transition between facets of the crimp sleeve after crimping, which is an advantage.

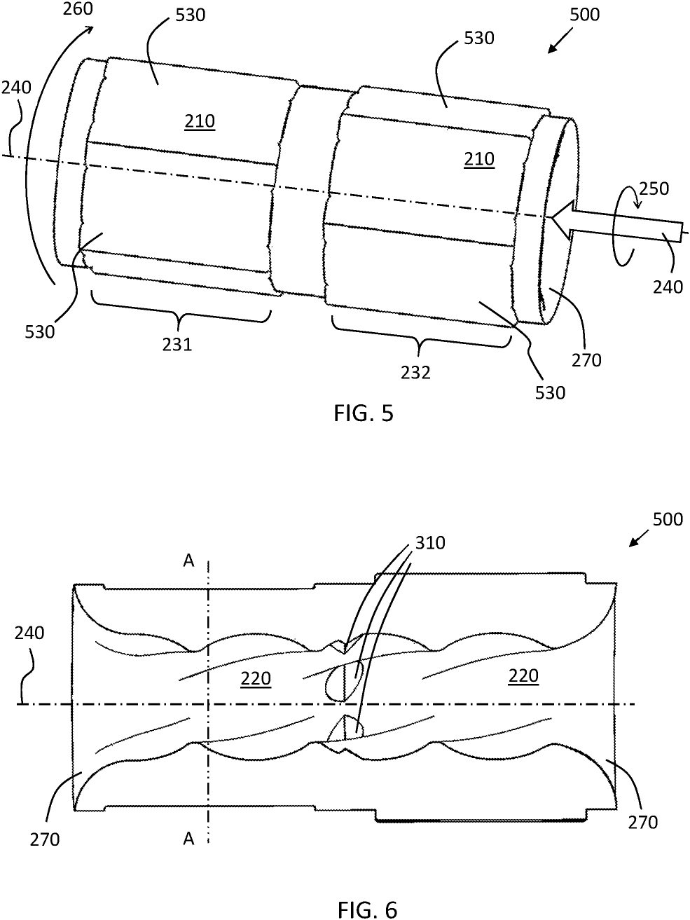

Another example crimp sleeve is shown in FIGS. 5-7. Here the guiding structure 530 comprises one or more facet surfaces. Each facet surface is arranged to support the crimp sleeve in the crimping tool 1200 at a respective pre-determined axial rotation angle 260. The facets have the same function as the ridges in FIG. 2 in terms of supporting the crimp sleeve in the crimping tool 1200 at a pre-determined axial rotation angle.

According to some aspects, the crimp sleeve 500 comprises six evenly distributed axial facet surfaces forming a hexagonal cross-section 540 of the crimp sleeve which matches the facets 1210 of the crimping tool 1200.

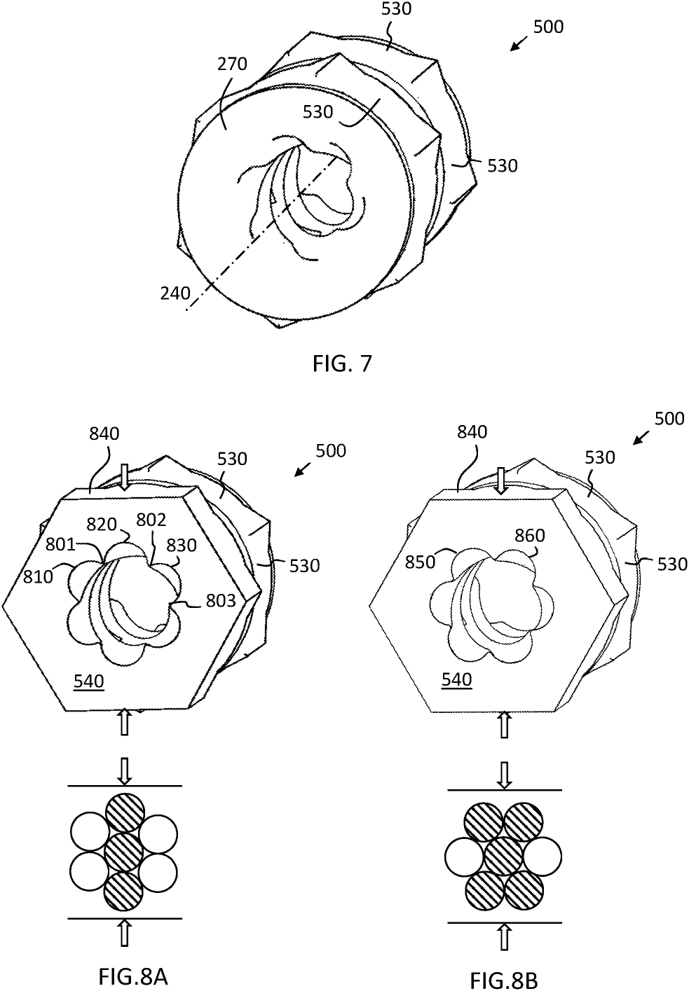

According to other aspects, as exemplified in FIGS. 5-7, the guiding structure 230, 530 is divided axially into a first portion 231 and a second portion 232. The first portion of the guiding structure is axially rotated with respect to the second portion of the guiding structure. This rotation provides for a more streamlined shape of the crimp sleeve since the guiding structure edges on the first and second portions extend radially in different directions. This can be seen, for instance, in FIG. 7.

The crimp sleeves discussed herein are dimensioned in dependence of the wire ends which they are configured to connect. Common wire dimensions used in wire saws for sawing concrete and stone comprise wires of diameter and tolerance 3.05+-0.05 mm, 3.55+-0.05 mm, 3.80+-0.05 mm, 4.45+-0.05 mm and 4.85+-0.05 mm. Smaller wires may also be used, such as wires having diameters on the order of 2.0 +-0.05 mm, 2.3 +-0.05 mm, and 2.5 +-0.05 mm.

The inner circumferential surface 220 defines an inner volume arranged to receive the wire ends. The crimp sleeve 200, 500 is dimensioned such that a small gap is formed between the wire and the crimp sleeve, i.e., with play. This gap is preferably configured in dependence of wire dimension as 0.2 mm for a cable of diameter 3.80 mm, 0.35 mm for a cable of diameter 4.45 mm, and 0.4 mm for a cable of diameter 4.85 mm. It is appreciated that, for every plane cutting along the main axis 240 of the sleeve, there are always two gaps formed between the inner surface of the sleeve and the outer surface of the wire, so the total distance available to fit the wire end into the receiving volume of the crimp sleeve is twice the above-mentioned gap. Thus, according to some aspects, the inner volume defined by the inner circumferential surface 220 is configured with play relative to a diameter of the wire ends.

FIGS. 3 and 6 show lengthwise cross-sections of the example crimp sleeves 200, 500. In both these examples, the inner circumferential surface 220 defines an inner volume arranged to receive the wire ends in fixed relation 250 to the one or more axial rotation angles 260. Here, the inner circumferential surface 220 comprises a helical ridge configured to enter a space between two strands of a wire end, whereby the wire ends are received in fixed relation 250 to the one or more axial rotation angles 260. This is one example of a crimp sleeve where the inner circumferential surface 220 is configured with a shape that is matched to an exterior profile of the wire ends. However, the inner circumferential surface 220 may also just comprise a respective protrusion for each wire end configured to enter a space between two strands of the wire end, whereby the wire ends are received in the inner volume in fixed relation 250 to the one or more axial rotation angles 260. The protrusion may, e.g., be a section of ridges, or just a tap extending into the volume.

By matching the inner circumferential surface 220 to the shape of the wire, improved friction is obtained between the inner circumferential surface and the wire surface after crimping. This improved friction leads to increased tensile strength, which is an advantage, particularly when it comes to wires for wire saws which are often exposed to large longitudinal forces along the wire.

The matching between inner circumferential surface and wire surface also means that shear forces must be overcome for the wire to get pulled out from the crimp sleeve unless the wire is allowed to rotate. These shear forces provide a pull resistance to further increase the tensile strength of the wire connection.

In other words, the matching between inner circumferential surface and wire surface means that the inner circumferential surface 220 has an at least partially complementary shape to the wire ends, or footprint. Thus, the “pitch” of the inner circumferential surface with the helical ridges depends on which wire that is to be crimped. For example, the at least partially complementary shape may correspond to a pitch between 24 mm and 35 mm, and preferably selected in dependence of wire diameter as 24 mm for a cable of diameter 3.80 mm, 32 mm for cable of diameter 4.45 mm and 35 mm for cable of diameter 4.85 mm. For these values and crimp sleeves of length between 15-25 mm, the rotation of each wire end as it enters the sleeve will be between 180 degrees and 360 degrees, however, rotations on the order of 90 degrees and more than 360 degrees are also possible.

The inner surface footprint rotation should be same as that of the wire, i.e., left or right oriented. The inner surface footprint should ideally also have same pitch as the pitch of the wire, although some small differences may be acceptable.

The radial diameter of the crimp sleeve is, according to some aspects, between 6 mm and 10 mm, and preferably selected in dependence of wire diameter as 7.5 mm for a cable of diameter 3.80 mm, 8.1-8.2 mm for cable of diameter 4.45 mm and 9 mm for cable of diameter 4.85 mm. Smaller diameters of the crimp sleeve are used for smaller sized wires.

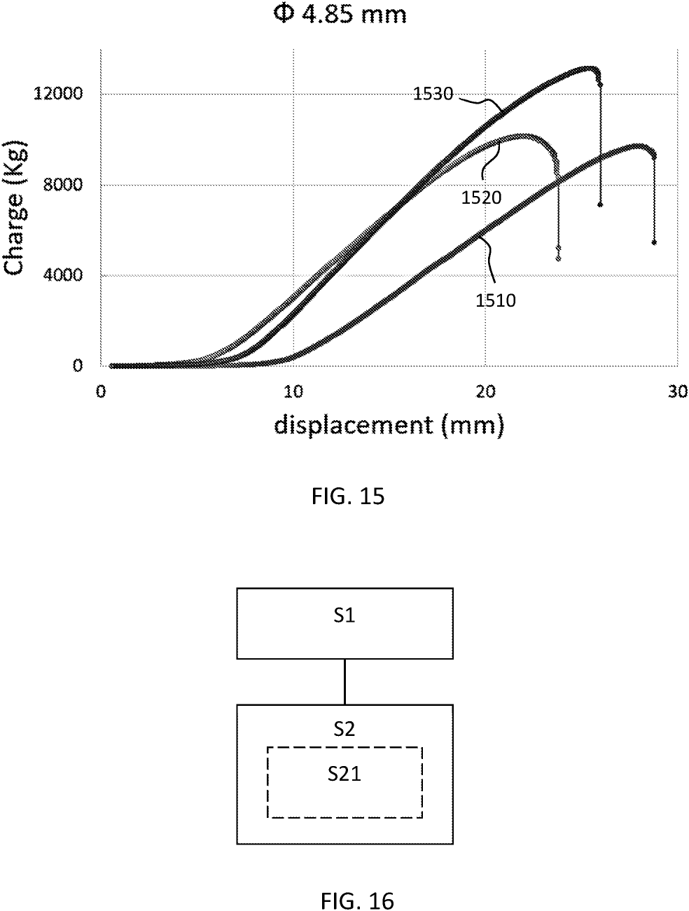

The improvement in tensile strength is exemplified in FIG. 15, which shows a graph of pull charge on a wire (in kg) vs wire displacement (in mm). The displacement increases with charge due to wire elasticity and also due to minor slippage of the wire in the crimp sleeve, until a point where the wire is pulled out from the crimp sleeve. This higher the charge when this happens, the larger the tensile strength of the wire connection.

Three curves are shown. The first curve 1510 is for a Standard ST37-2 wire connector. The second curve 1520 is for a 3DP- 316L straight wire connector, while the third curve is for a crimp sleeve according to the present disclosure. It is noted that the increase in tensile strength is about 30%, which is a remarkable improvement over the known crimp sleeves.

FIGS. 14A and 14B schematically illustrate parts of the crimping process. A cable 1420 for a wire saw comprises abrasive beads 1410. The core of the cable is a wire rope 1430 comprising wires which make up strands. There are normally seven strands to a wire, as shown in FIGS. 8A and 8B. Wire ends are inserted into a crimp sleeve 200, 500, 900 according to the discussion herein, which sleeve is then crimped by a crimping tool 1200. The rotation angle of the crimping tool with respect to the sleeve is guided by the guiding structure 230, 530 on the sleeve. After the crimping tool has been applied, the sleeve is rotated by a pre-determined amount, here shown as 60 degrees, and the sleeve is again guided in the crimping tool by the guiding structure 230, 530 on the sleeve. The process is then repeated until the crimping is complete.

With reference to FIGS. 4 and 7, the opening of the sleeve configured to receive a wire end preferably has a funnel shape 270, or a rounded chamfer, with a chamfer radius between 0.5 mm and 2.0 mm. Other sharp edges of the crimp sleeve are preferably also chamfered, but then at a radius between 0.1 mm and 0.2 mm radius

Compared to the prior art sleeve shown in FIG. 1, this chamfer in the sleeve opening has the technical effect of reducing the strain on the wire during a bend, since the bend radius of the wire is increased compared to the case where the opening is a sharp edge around which the wire bends.

The funnel shape 270 or rounded chamfer at the openings of the crimp sleeve is also seen in FIGS. 3 and 6. The funnel shape here gradually transfers into an inner circumferential surface 220 matched to the shape of the wire.

According to aspects, the crimp sleeves 200, 500, 900 have inner circumferential surfaces 220 which comprise a stopping member 310 arranged as a stop in the crimp sleeve to separate the two wire ends and to prevent a wire end from traversing through the crimp sleeve.

FIGS. 8A and 8B illustrate the possibility to configure different pre-determined axial rotation angles 260. FIGS. 8A and 8B show cross sections taken just after the funnel shaped portion 270, i.e., approximately 1 mm from the extreme point of the sleeve, at the limit of crimped zone.

The above-mentioned ridges 801, 802, 803 which enter the spaces between the wire strands force the wire strands to remain in the volumes 810, 820, 830 between the ridges, and therefore the wire assumes the configured axial rotation angle.

In FIG. 8A, the pre-determined axial rotation angle 260 has been selected such that three strands of the wire are subjected to the main crimping force. This particular configuration has shown to be advantageous for applications involving smaller diameter pulleys, where the wire is subjected to increased bending forces.

In FIG. 8B, the configuration is instead such that five wire strands are subject to the main crimping force. This particular configuration has shown to be advantageous for applications where the wire is instead subject to severe tensile stress, i.e., where the pull force on the wire is significant.

A designer may, by the presently disclosed technique, design a crimping angle which fits the intended wire saw application or use case. This design may be performed using mechanical simulation or by practical experimentation.

Another advantage obtained from the disclosed crimp sleeves is that a consistency in the crimping process is obtained, since every wire end connection is crimped in the same way, with the same force and at the same axial rotation angle. This improves the possibilities to estimate expected lifetime of a wire used in a wire saw, which is an advantage.

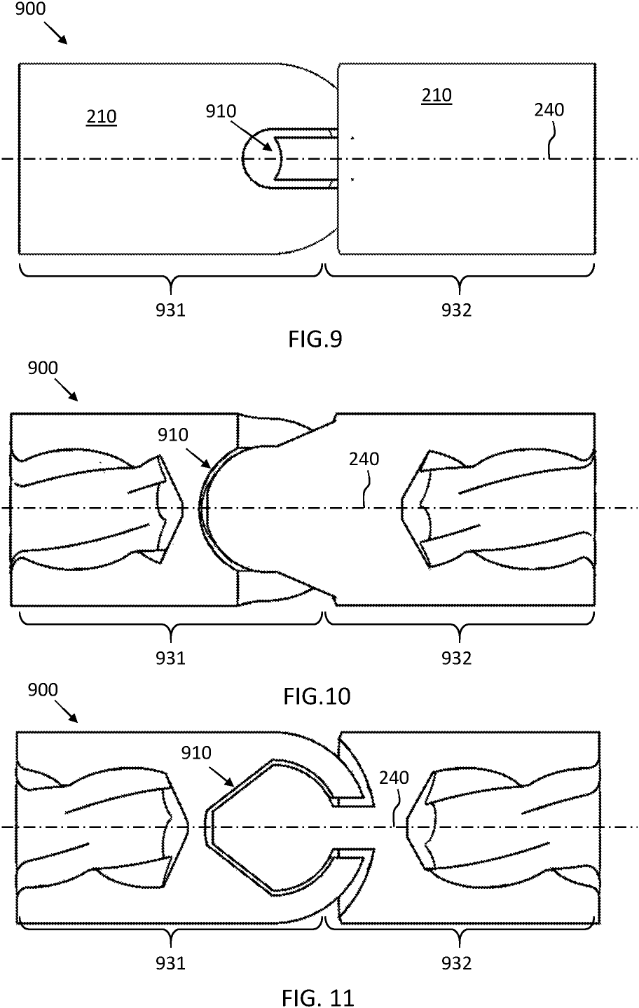

FIGS. 9-11 show example crimp sleeves which may comprise any of the guiding structures and inner circumferential surfaces discussed above. The example crimp sleeves shown here are divided into first 931 and second 932 articulated parts, where each part is arranged to receive a respective wire end. According to aspects, the first part 931 and the second part 932 are connected via a ball joint 910.

This way the wear due to bending reduces further, since the bend radius of the wire as it traverses past, e.g., a pulley, is further increased. The stress on the individual wires there is reduced, and the lifetime of the wire increases, which is an advantage.

To summarize some of the discussions above, there has been disclosed herein a crimp sleeve 200, 500, 900 arranged to join two ends of a wire for a wire saw. The crimp sleeve is arranged to receive 245 the wire ends from opposite sides along an axial direction 240 of the sleeve. The crimp sleeve has an outer circumferential surface 210 and an inner circumferential surface 220, wherein the inner circumferential surface 220 has an at least partially complementary shape to the wire ends.

In other words, each wire end has a surface shape, and the inner circumferential surface has a shape which is at least partially complementary wire end surface shape. This means that the inner surface shape has at least some portions which resemble a footprint of the strands of the wire.

According to aspects, a length of the crimp sleeve along the axial direction is between 11 mm and 25 mm, and preferably between 16 mm and 20 mm.

According to aspects, a radial diameter of the crimp sleeve is between 6 mm and 10 mm, and preferably selected in dependence of wire diameter as 7.5 mm for a cable of diameter 3.80 mm, 8.1-8.2 mm for cable of diameter 4.45 mm and 9 mm for cable of diameter 4.85 mm.

According to aspects, the at least partially complementary shape corresponds to a pitch between 24 mm and 35 mm, and preferably selected in dependence of wire diameter as 24 mm for a cable of diameter 3.80 mm, 32 mm for cable of diameter 4.45 mm and 35 mm for cable of diameter 4.85 mm.

FIG. 16 is a flow chart illustrating methods. In particular, there is shown a method for producing a batch of crimp sleeves 200, 500, 900. The method comprises configuring S1 a device for additive manufacturing and forming S2 each crimp sleeve by the device for additive manufacturing. Each of the formed crimp sleeves is arranged to receive two wire ends from opposite sides of the sleeve along an axial direction 240 of the sleeve. Each crimp sleeve also has an outer circumferential surface 210 and an inner circumferential surface 220, wherein the outer circumferential surface 210 comprises a guiding structure 230, 530 arranged to guide a crimping tool 1200 to crimp the sleeve at one or more pre-determined axial rotation angles 260, and wherein the inner circumferential surface 220 is arranged to receive the wire ends in fixed relation 250 to the one or more axial rotation angles 260.

According to some aspects, the method also comprises forming S21 each crimp sleeve divided into first 931 and second 932 articulated parts, such as illustrated in FIGS. 9-11, where each part is arranged to receive a respective wire end.

According to some other aspects, the batch of crimp sleeves comprises between 200 and 400 crimp sleeves, and preferably about 300 crimp sleeves.

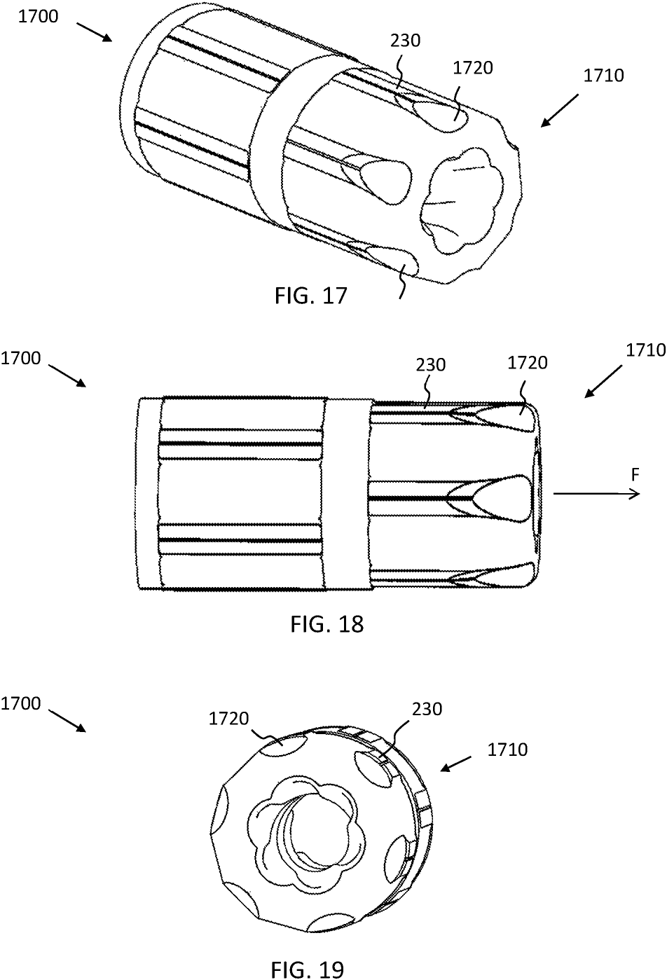

FIGS. 17-19 show different angles of an example crimp sleeve 1700. A forward end of the crimp sleeve 1710, intended to face in the running direction of the wire during use, here comprises one or more chamfered sections 1720. In this example the crimp sleeve comprises six equally spaced chamfered sections around the outer edge of the end of the sleeve. It is, however, possible to design the crimp sleeve with different spacings between the chamfered sections and to use different numbers of chamfered sections. It is also possible to design the crimp sleeve with a single chamfered section spanning around the whole edge of the end of the sleeve. The example crimp sleeve 1700 in FIGS. 17-19 comprises chamfered sections in connection to respective guiding structures 230, which in this example are in the form of ridges but could as well be facet surfaces 530. The chamfered sections are not necessarily arranged in connection to the guiding structures. The edge of the crimp sleeve can be chamfered on any of the crimp sleeves disclosed herein, such as the examples shown in FIGS. 2, 5, 9 and 17.

One purpose of the chamfered section is to make the transition from the outer edge of the end of the sleeve onto the axial extension direction smoother. Without the chamfered sections, the sleeve may be prone to undesired high friction or even shocks when it is received by a groove during use of the wire. For example, when a crimp sleeve arranged on a wire saw enters a cut of a stone block being sawed, the edges of the end of sleeve may snag on the walls of the cut. Corners along the circumference of the end of sleeve pose an especially large problem. Therefore, it is desired to smooth such corners through chamfering. The corners can be formed between adjacent facet surfaces. Corners can also arise from the crimping of the sleeve. It is often sufficient to arrange chamfered sections on only one end of the crimp sleeve since crimp sleeves are often only intended to be moving in a single direction, e.g., when arranged in a wire saw.

At least one chamfered section may be spoon-shaped. A “spoon-shape” here means that the surface of the chamfered section is spherical, or somewhat spherical, similar to the inner surface of bowl. Such a shape further helps to reduce friction and shocks when the sleeve is inserted into a groove. A chamfered section can of course also have other shapes, such as planar or more general shapes.

1. A crimp sleeve for joining two wire ends, wherein the crimp sleeve is arranged to receive the wire ends from opposite sides along an axial direction of the sleeve, the crimp sleeve having an outer circumferential surface and an inner circumferential surface,
wherein the outer circumferential surface comprises a guiding structure arranged to guide a crimping tool to crimp the sleeve at one or more pre-determined axial rotation angles.

2. The crimp sleeve according to claim 1, wherein the inner circumferential surface defines an inner volume arranged to receive the wire ends in fixed relation to the one or more axial rotation angles.

3. The crimp sleeve according to claim 1, wherein the guiding structure comprises two or more ridges extending axially along the outer circumferential surface.

4. The crimp sleeve according to claim 3, comprising six ridges evenly distributed around the outer circumferential surface in pairs, wherein each pair of ridges is arranged to support the crimp sleeve in the crimping tool at one of the one or more pre-determined axial rotation angles.

5. The crimp sleeve according to claim 1, wherein the guiding structure comprises one or more facet surfaces, wherein each facet surface is arranged to support the crimp sleeve in the crimping tool at a respective pre-determined axial rotation angle.

6. The crimp sleeve according to claim 5, comprising six evenly distributed axial facet surfaces forming a hexagonal cross-section of the crimp sleeve.

7. The crimp sleeve according to claim 1, wherein the pre-determined axial rotation angles comprise multiples of 60 degrees.

8. The crimp sleeve according to claim 1, wherein the guiding structure is divided axially into a first portion and a second portion, wherein the first portion of the guiding structure is axially rotated with respect to the second portion of the guiding structure.

9. The crimp sleeve according to claim 1, wherein the inner circumferential surface comprises a respective protrusion for each wire end configured to enter a space between two strands of the wire end, whereby the wire ends are received in the inner volume in fixed relation to the one or more axial rotation angles.

10. The crimp sleeve according to claim 1, wherein the inner circumferential surface comprises a helical ridge configured to enter a space between two strands of a wire end, whereby the wire ends are received in fixed relation to the one or more axial rotation angles.

11. The crimp sleeve according to claim 1, wherein the inner circumferential surface is configured with a shape that is matched to an exterior profile of the wire ends, or wherein the inner circumferential surface s atced to aeteooe ote we ends, or wherein the inner circumferential surface comprises a stopping member arranged as a stop in the crimp sleeve to separate the two wire ends and to prevent a wire end from traversing through the crimp sleeve.

12. (canceled)

13. The crimp sleeve according to claim 1, wherein an overall length of the crimp sleeve measured along the axial direction is between 16-20 mm or wherein an opening of the sleeve configured to receive a wire end has a funnel shape (270) with a chamfer radius between 0.5-2.0 mm.

14. (canceled)

15. The crimp sleeve according to claim 1, wherein the inner volume is configured with play relative to a diameter of the wire ends.

16. The crimp sleeve according to claim 1, wherein the sleeve is divided into first and second articulated parts connected via a ball joint, and wherein each of the first and second articulated parts is arranged to receive a respective wire end.

17. (canceled)

18. The crimp sleeve according to claim 1, wherein one end of the crimp sleeve comprises one or spoon shaped more chamfered sections.

19. (canceled)

20. A crimp sleeve arranged to join two ends of a wire for a wire saw, wherein the crimp sleeve is arranged to receive the wire ends from opposite sides along an axial direction of the sleeve, the crimp sleeve having an outer circumferential surface and an inner circumferential surface,
wherein each wire end has a surface shape, and wherein the inner circumferential surface has a shape which is at least partially complementary to the wire end surface shape, or
wherein the sleeve is divided in to first and second articulated parts, wherein each part is arranged to receive a respective wire end, or
wherein an opening of the sleeve configured to receive a wire end has a funnel shape with a chamfer radius between 0.5-2.0 mm.

21. The crimp sleeve according to claim 20, wherein a length of the crimp sleeve along the axial direction is between 11 mm and 25 mm.

22. The crimp sleeve according to claim 20, wherein a radial diameter of the crimp sleeve is between 6 mm and 10 mm, or
wherein the at least partially complementary shape corresponds to a pitch between 24 mm and 35 mm.

23-27. (canceled)

28. A method for producing a batch of crimp sleeves, the method comprising
configuring a device for additive manufacturing,
forming each crimp sleeve by the device for additive manufacturing, wherein each crimp sleeve is arranged to receive two wire ends from opposite sides of the sleeve along an axial direction of the sleeve, the crimp sleeve having an outer circumferential surface and an inner circumferential surface, wherein the outer circumferential surface comprises a guiding structure arranged to guide a crimping tool to crimp the sleeve at one or more pre-determined axial rotation angles, and wherein the inner circumferential surface is arranged to receive the wire ends in fixed relation to the one or more axial rotation angles.

29. The method according to claim 28, comprising forming each crimp sleeve divided into first and second articulated parts, wherein each part is arranged to receive a respective wire end, and wherein the batch of crimp sleeves comprises between 200 and 400 crimp sleeves.

30. (canceled)
